(19) United States
(12) Patent Application Publication
(10) Pub. No.: US 2009/0043768 A1
(43) Pub. Date: Feb. 12, 2009

(54) METHOD FOR DIFFERENTIATING STATES OF N MACHINES

(75) Inventor: Jack A. Nichols, Kirkland, WA (US)

Correspondence Address: DAVIS WRIGHT TREMAINE, LLP/Seattle, 1201 Third Avenue, Suite 2200, SEATTLE, WA, 98101-3045, US

(73) Assignee: Kivati Software, LLC, Bellevue, WA (US)

(21) Appl. No.: 12/115,479

(22) Filed: May 5, 2008

Related U.S. Application Data
(60) Provisional application No. 60/915,846, filed on May 3, 2007.

(51) Int. Cl. G06F 7/20; G06F 17/30

(52) U.S. Cl. 707/6; 707/E17.014

(57) ABSTRACT

A differentiating system and method for differentiating states of N machines computes and stores differences between N machine states. The differentiating system takes as input a list of item keys and data for items of two or more states and produces as output a list of the item keys of items that are different between the N machine states, and the reason for the differences. Additionally, the differentiating system does not require knowledge of the item data contained in the N states.

### CROSS REFERENCE TO RELATED APPLICATION(S)

This application claims priority benefit of provisional application Ser. No. 60/915,843 filed May 3, 2007, the content of which is incorporated in its entirety.

This application is related to copending application by Jack A. Nichols, entitled “A Method For Determining And Storing The State Of A Computer System”, filed on May 5, 2008, which application is hereby incorporated by reference in its entirety, including any appendices and references thereto.

This application is related to copending application by Jack A. Nichols, entitled “A Method Of Determining Dependencies Between Items In A Graph In An Extensible System”, filed on May 5, 2008, which application is hereby incorporated by reference in its entirety, including any appendices and references thereto.

This application is related to copending application by Jack A. Nichols, entitled “A Method For Performing Tasks Based On Differences In Machine State”, filed on May 5, 2008, which application is hereby incorporated by reference in its entirety, including any appendices and references thereto.

### BACKGROUND OF THE INVENTION

1. Field of the Invention

The present invention is directed generally to extensible software systems.

2. Description of the Related Art

The states of modern computer systems are complex and contain a large amount of data. It is sometimes important to detect when a difference occurs between the state of two computer systems. Detecting differences can give one a great deal of information about a computer system, and can help identify problems as well as identify what steps need to be taken to complete an action, such as for troubleshooting, maintenance, or deployment.

Modern computer systems store data in a variety of mediums. Data storage mediums are either volatile or non-volatile. The content of data in volatile mediums is erased whenever the computer system is powered off. The content of data in non-volatile mediums, by contrast, persists through power cycles.

Volatile mediums in modern computer systems include the main system memory (RAM), the processor's cache memory, the processor's registers, and any other caching systems present in the computer, such as a hard disk cache. Non-volatile mediums in modern computer systems include hard disks, removable disks, and storage devices (such as floppy disks, CD and DVD discs, USB drives, etc).

While the data stored in volatile mediums is useful for the operation of a computer system, it is the data stored in non-volatile mediums that defines how the computer system operates. Consider two identical pieces of computer hardware A and B. If hardware A contains non-volatile data X, we can make hardware B behave exactly like hardware A by copying non-volatile data X to hardware B. We refer to X as the state of hardware A, and in general the non-volatile data stored in a computer system as the state of the computer system.

Each state contains a set of individual items. Consider machine A and machine B having items {A₀, A₁, . . . , A_{N}} and {B₀, B₁, . . . , B_{N}}, respectively. Each item represents an individual object in the state, such as a file, database, configuration, or other piece of data.

Although it may desirable to detect differences at a whole system-level, such as saying “machine A is different from machine B”, most often it is more interesting to look for differences at an individual item level. For example, if a file “C:\File.txt” has changed, it may be interesting to only see that change, as opposed to that the entire system has changed.

### BRIEF DESCRIPTION OF THE SEVERAL VIEWS OF THE DRAWING(S)

FIG. 1 is a schematic block diagram of a computer and associated equipment that is used with implementations of the system.

FIG. 2 is a schematic depicting sample file system input data to be inputting to the differentiating system.

FIG. 3 is a schematic depicting a second set of sample file system input data to inputted to the differentiating system.

FIG. 4 is a schematic depicting use of a merge strategy as part of the differentiating system.

### DETAILED DESCRIPTION OF THE INVENTION

As will be discussed herein, a differentiating system and method for differentiating states of N machines computes and stores differences between N machine states. The differentiating system takes as input a list of item keys and data for items of two or more states and produces as output a list of the item keys of items that are different between the N machine states, and the reason for the differences. Additionally, the differentiating system does not require knowledge of the item data contained in the N states.

The differentiating system presented embodies the notation:

(A0+A1+A2+ . . . +AN)−>B=E

Where A0 . . . N represent the source states of N computer hardware A, B represents the target state of a computer hardware B, and E represents the set of differences. Conceptually, the differentiating system provides an answer to the following question: Given A0 . . . N, what changes (E) should be performed in state B to make state B identical to A0 . . . N?

In implementations, the input to the differentiating system is the output from the procedure described in a co-pending patent application entitled, “Method for determining and storing the state of a machine.” Any procedure that implements a behavior similar to the aforementioned method could be used as input to the differentiating system, however. The primary requirement is that the state includes a series of unique and predictable keys for each item, and that the state provides access to the data for each item key.

To avoid having knowledge of each item, the differentiating system considers only the hash of each item's data when computing differences between states. The hash is considered because the hashed data is a fixed, predictable size, and comparison of such data is very fast and efficient. Additionally, a hash of the data does not need knowledge of the data format for each item. The hash system can be any valid one-way hash system such as MD5 or SHA1. These two hash systems are used in some of the implementations because the likelihood of collisions is extremely low.

A drawback of the hash comparisons is that the data for each item should be exactly identical in order for two items to be considered identical. Therefore, it is incumbent upon the process providing the input to ensure that two items that are identical are provided with identical data in an identical format.

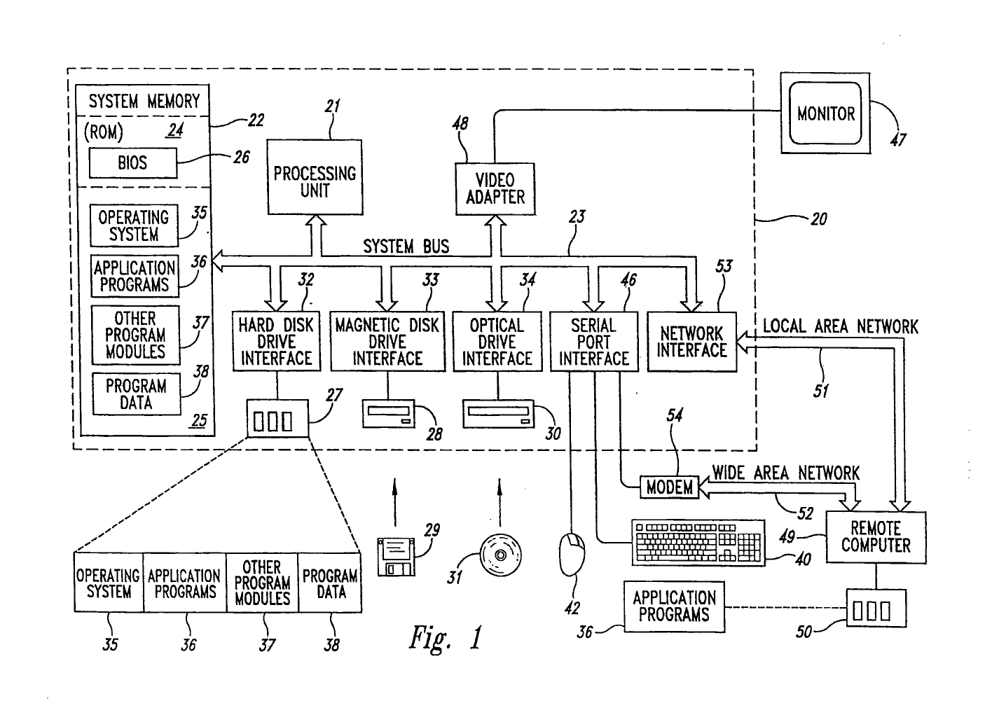

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

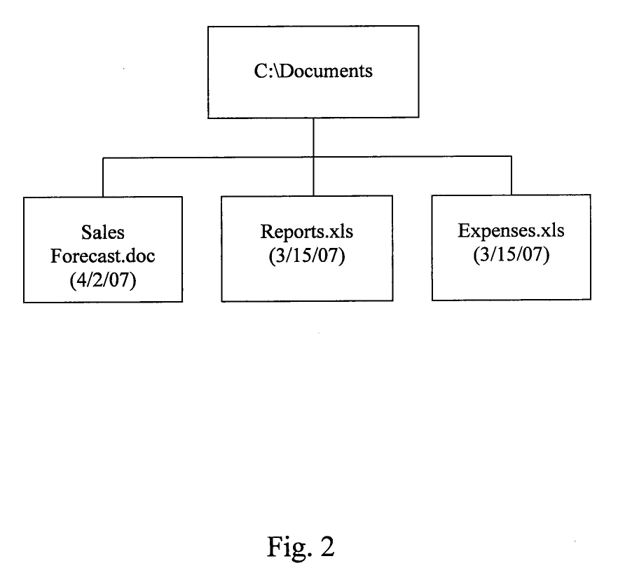

Consider the following file system structure shown in FIG. 2. This structure represents a simple directory with a few files. The date beneath each file represents the date on which it was last changed. We'll call this state of the file system State A.

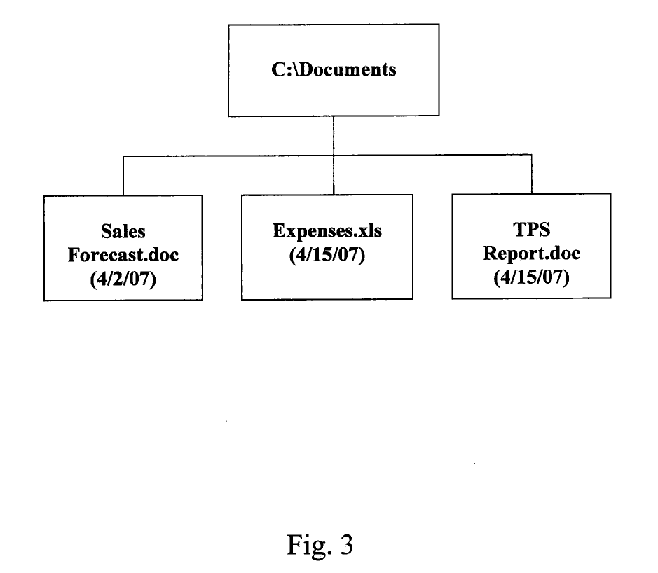

Now, consider the following file system structure shown in FIG. 3. This structure represents the same file system from State A at some later point in time. We'll call this diagram's contents State B. Note the following changes from A to B:
Expenses.xls has changed (later date)
A new file, TPS Report.doc, has been added
Reports.xls has been deleted
   Also note that Sales Forecast.doc is unchanged.
   We can represent the difference in states with the following table:

TABLE 1

| Item | Difference |
|---|---|
| C:\Documents | Same |
| Sales Forecast.doc | Same |
| Reports.xls | Not in B |
| Expenses.xls | Different |
| TPS Report.doc | Not in A |

More succinctly, the differentiating system can omit items that have difference type of “Same”, and can represent the set E where A->B=E as:

TABLE 2

| Item | Difference |
|---|---|
| Reports.xls | Not in B |
| Expenses.xls | Different |
| TPS Report.doc | Not in A |

The differentiating system includes two conceptual phases. In the first phase, the differentiating system combines the states (A₀+A₁+A₂+ . . . +A_{N}) into a single state, A′. This phase is called merging. This phase is skipped if only one source state is provided. In the second phase, the differentiating system compares states A′ to B and generates the output set of differences E. An actual implementation of the differentiating system may choose to perform these phases independently, or simultaneously.

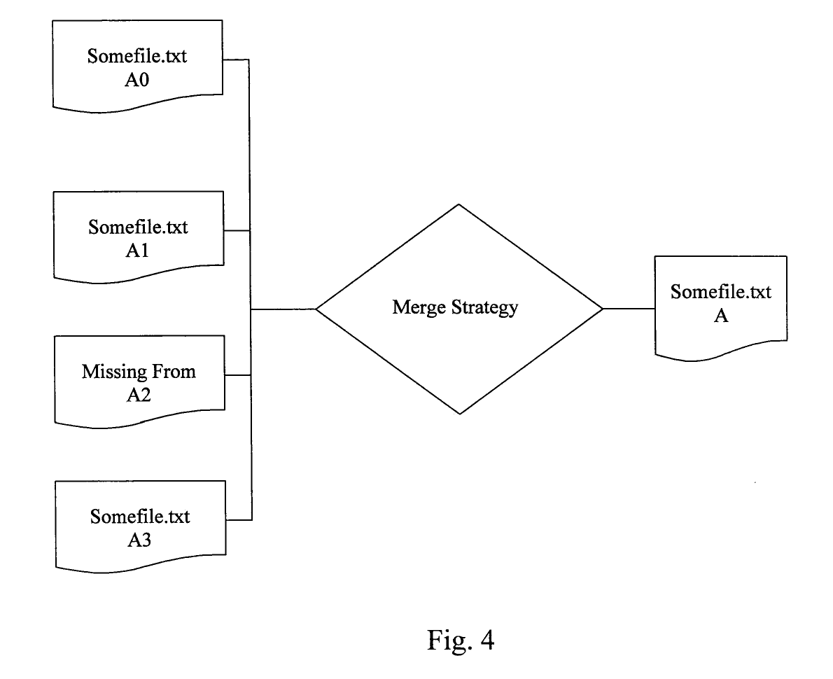

To perform merging, the differentiating system uses a special extension (a type of pluggable executable code) called a merge strategy. A merge strategy takes as input each input state and the key to merge, and returns as output the merged data. A merge strategy is not required if this phase is to be skipped. The resulting merged data and input key is placed into A′ and used for comparison with this process being depicted in FIG. 4. The merge strategy takes input from A₀, A₁, and A₃ for key “Somefile.txt”. Note that A2 provides input in the form that “Somefile.txt” is not present in A₂. The merge strategy makes a decision on the data that should be provided as output for “Somefile.txt”, and provides it to A′.

It is up to the merge strategy how to provide data for output. A merge strategy could be very simple, and simply pick the item from the first input. Alternatively, a merge strategy could be complex, and employ its own set of providers to analyze the data contained within each item and generate a new item for A′. There is some cost associated with more complex merge strategies, and some implementations of the invention may choose to only allow merge strategies to select an existing item instead of creating a combination item from the inputs.

The differences between machines can be expressed as a set of individual differences between items. Consider machine A and machine B. Set E={D₀, D₁, D₂, . . . D_{N}} represents the individual differences between the state of machine A and the state of machine B, with each item D_{N} representing an individual difference in the machines. For notational purposes, the notation A->B=E indicates that the set E represents the differences between A and B. It is worthwhile to note that, in this notation, A−>B==B->A.

There are several different types of individual differences that can be expressed between states A and B. These include:
Not in A, where a difference exists because A does not contain the item.
Not in B, where a difference exists because B does not contain the item.
Different, where the item exists in both sets A and B, but is different.
Same, where the item exists and is the same in both A and B.

In many cases, the term Different may be insufficient to describe the individual difference. It may, for example, be more appropriate to describe why a difference exists. Thus, the category of Different can contain many sub-categories that describe why the item is different. It is worthwhile to note that an item can be different due to multiple causes, and therefore the category of Different may have more than one sub-category describing the difference associated with it.

The difference set E can be thought of as a description of the differences between A and B. However, if the order between A and B is preserved, they can also be considered the actions to take to make the states equal. By way of example, if A->B={D} where D=“File c:\test.txt not exist in B”, this can be translated to the action “Create file c:\test.txt in B”. After this action is performed, then A->B={} (the empty set). By way of notation, A->(B+D)={}, and one can refer to A as the source and B as the target states.

Computing the difference between two states is a complex task. For each item X in state A, the item should be located in state B and compared. In order for this operation to be efficient, a mechanism should be in place such that locating and comparing an individual item occurs in a reasonable amount of time. The co-pending patent application entitled, “Method for determining and storing the state of a machine,” describes a state storage mechanism that provides this property, although any mechanism that provides this property could be used.

Computing the difference between items in two states requires knowledge of the items being compared. As described in the co-pending patent application entitled, “Method for determining and storing the state of a machine,” this responsibility can be delegated to extension modules such that the comparison system does not require this knowledge. Although some items, such as files, can be compared as streams of bytes, other items, such as database tables, may require a more granular comparison. For example, in a database table, one may wish to compare individually the table's columns, rows, indexes, primary keys, foreign keys, and constraints so that one can identify the differences between each type of object.

The pseudocode for both phases of this differentiating system is shown below. In the pseudocode, the notation A[key] represents the item data represented by key in the state A. The notation Hash(x) represents the hash value of data x. The differentiating system takes as input:
Sources, an array of source machine state objects
Target, a machine state representing the target for comparison
MergeStrategy, a function pointer to the merge strategy for the merging phase. The MergeStrategy function takes as input:
Sources, the array of source states from which to merge
Key, the key to examine in each state
   It returns a reference to the data to compare for A′.

### Pseudocode:

```
TABLE 3
Procedure ComputeDifferences(Sources, Target, MergeStrategy)
    Let E = an empty set for holding differences
    Let AllKeys = an empty array
    -- first, combine the keys from all states, including source and target
    For each State in Sources
        For each Key in State.Keys
            If (Key is not in AllKeys)
                Add Key to AllKeys
    For each Key in Target.Keys
        If (Key is not in AllKeys)
            Add Key to AllKeys
    -- Keys now contains all keys from all states
    -- now, merge and compare
    For each Key in AllKeys
        -- merge the data using the merge strategy
        Let A′ = MergeStrategy(Sources, Key)
        -- get the data from the target
        Let B = Target[Key]
        -- hash both data items
        -- one or both could be null if the data doesn't exist
        Let hA = Hash(A′)
        Let hB = Hash(B)
        -- compare and generate a difference
        if hA does not equal hB
            -- they are different
            Store (Key, Different) in E
        else if hA is null and hB is not null
            -- not in a
            Store (Key, Not in A) in E
        else if hA is not null and hB is null
            -- not in b
            Store (Key, Not in B) in E
        else
            -- they are the same, don't do anything
    -- done
    return E
End Procedure
```

Let's walk through a simple example. Consider state A, with its keys and data:

TABLE 4

| Key | Data |
|---|---|
| C:\Documents | Changed 3/1/07 |
| Sales Forecast.doc | January = $100,000 |
| Reports.xls | January = 12, February = 18 |
| Expenses.xls | Los Angeles = $1,314 |

Now, consider state B, with its keys and data:

TABLE 5

| Key | Data |
|---|---|
| C:\Documents | Changed 3/1/07 |
| Sales Forecast.doc | January = $100,000 |
| Expenses.xls | Los Angeles = $1,314, New York = $2,531 |
| TPS Report.doc | Cover sheet, title page |

First, the differentiating system initializes its empty set E and an array AllKeys of keys.
Next, all keys from all source and target states are combined:

```
TABLE 6
-- first, combine the keys from all states, including source and target
For each State in Sources
    For each Key in State.Keys
        If (Key is not in AllKeys)
            Add Key to AllKeys
For each Key in Target.Keys
    If (Key is not in AllKeys)
        Add Key to AllKeys
```

The resulting array AllKeys now contains the following elements:

TABLE 7

| | | | | |
|---|---|---|---|---|
| C:\Documents | Sales | Reports.xls | Expenses.xls | TPS |
| | Forecast.doc | | | Report.doc |

Now, the differentiating system begins comparing keys. Because there is only one source state in this example, the merge strategy is irrelevant and A′ will always equal Sources[0][Key], where Sources[0] refers to the first and only item in the Sources list.
On the first iteration of the loop, the Key will be “C:\Documents”, and after this code:

TABLE 8

-- merge the data using the merge strategy
Let A′ = MergeStrategy(Sources, Key)
-- get the data from the target
Let B = Target[Key]
-- hash both data items
-- one or both could be null if the data doesn't exist
Let hA = Hash(A′)
Let hB = Hash(B)

The variables will contain the following data:

TABLE 9

| Key | C:\Documents |
|---|---|
| A′ | Changed 3/1/07 |
| B | Changed 3/1/07 |
| hA | 0x7ec1ad1ee5412a4517f81c966b88832f |
| hB | 0x7ec1ad1ee5412a4517f81c966b88832f |

Because hA is equal to hB, the key “C:\Documents” will not be added to E.
Regarding the next key, “Sales Forecast.doc”. When the variables are constructed for this key, the variables will contain the following data:

TABLE 10

| Key | Sales Forecast.doc |
|---|---|
| A′ | January = $100,000 |
| B | January = $100,000 |
| hA | 0xb6f0d4e66e4d57269bbc2a5635a2a4c8 |
| hB | 0xb6f0d4e66e4d57269bbc2a5635a2a4c8 |

Again, hA is equal to hB, and so the key “Sales Forecast.doc” will not be added to E. Next is “Reports.xls”. This key is present in the source and not in the target, and so the variables will be:

TABLE 11

| Key | Reports.xls |
|---|---|
| A′ | January = 12, February = 18 |
| B | (null) |
| hA | 0xdcd733be9d41139999193fb04d99a6be |
| hB | (null) |

Because hB is null, this key will be added to E with a Not in B difference type.
Therefore, E now contains the following:

Reports.xls, Not in B

The next key is “Expenses.xls”. This key is present in both states. The variables will contain:

TABLE 12

| Key | Expenses.xls |
|---|---|
| A′ | Los Angeles = $1,314 |
| B | Los Angeles = $1,314, New York = $2,531 |
| hA | 0xfd03cbb27c295e4a4a0dc9182672a092 |
| hB | 0xcebca2ad813432d85f27d198c4653ef4 |

Because hA and hB are different, this key will be added to E with a Different difference type. E now contains the following:

| | |
|---|---|
| Reports.xls, Not in B | Expenses.xls, Different |

Finally, the last key is “TPS Report.doc”. This key is not in A, but is present in B. The variables will contain:

TABLE 13

| Key | TPS Report.doc |
|---|---|
| A′ | (null) |
| B | Cover sheet, title page |
| hA | (null) |
| hB | 0xf2c6d1f403fedd9ffd55fad0b887c7f2 |

Because hA is null, the key will be added to E with a Not in A difference type. E will then contain the following:

| | | |
|---|---|---|
| Reports.xls, Not in B | Expenses.xls, Different | TPS Report.doc, |
| | | Not in A |

The differentiating system is now complete, and E now contains the differences between states A and B.
The resulting difference set E can now be used for a variety of purposes. Most obviously, we can immediately spot the individual differences in the state of the machine. If these differences represented configuration settings, for example, we could very quickly identify problems or the source of behavioral differences. Another application of the difference set is changing the state of a machine to replicate another state.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of depictions and other examples. Insofar as such depictions and examples contain one or more functions and/or operations, it will be understood as notorious by those within the art that each function and/or operation within such depictions and examples can be implemented, individually and/or collectively, by a wide range of hardware, software, firmware, or virtually any combination thereof.

From the foregoing it will be appreciated that, although specific implementations of the invention have been described herein for purposes of illustration, various modifications may be made without deviating from the spirit and scope of the invention. Accordingly, the invention is not limited except as by the appended claims.

The invention claimed is:

1. For a first computer hardware having a source state and a second computer hardware having a target state, a method comprising:
receiving a first list of keys, each of the keys associated with a different one of a first plurality of items of the source state;
receiving a second list of keys, each of the keys associated with a different one of a second plurality of items of the target state;
comparing the first list with the second list; and
outputting a list of keys of items that are different between the first plurality of items of the source state and the second plurality of items of the target state without requiring knowledge of the items of the source state and the target state.

2. The method of claim 1 wherein comparing includes comparing a hash for each item of the first list of keys and the second list of keys to allow comparing without requiring knowledge of the items of the source state and the target state.

3. The method of claim 2 wherein the hash for each item is a one-way hash.

4. The method of claim 3 wherein the comparing a hash includes one of MD5 and SHA1.

5. The method of claim 1 wherein the source state is a combination of a plurality of source states.

6. The method of claim 1 wherein the outputting includes indicating reasons for differences between the first plurality of items of the source state and the second plurality of items of the target state.

7. The method of claim 6 wherein the reasons are expressed in terms including not in source, not in target, different, and same.

8. The method of claim 7 wherein the different expression has sub-categories.

9. The method of claim 1 wherein the outputting preserves order between the source state and the target state so that the list of keys of items that are different has information to act upon to make the source state equal to the target state.

10. The method of claim 1 wherein comparing includes for each item of the source state an item in the target state is located and compared.

11. The method of claim 1 wherein the items of the source state and the items of the target state include files.

12. The method of claim 1 wherein the items of the source state and the items of the target state include files, folders, database tables, database views, database table columns, database table rows, database metadata, database scripts, security descriptors, computer metadata, or other objects or data used.

13. For a plurality of source computer hardware having a plurality of source states and a target computer hardware having a target state, a method comprising:
merging data and keys of each of the plurality of source states into a single source state;
receiving a first list of keys, each of the keys associated with a different one of a first plurality of items of the single source state;
receiving a second list of keys, each of the keys associated with a different one of a second plurality of items of the target state;
comparing the first list with the second list; and
outputting a list of keys of items that are different between the first plurality of items of the single source state and the second plurality of items of the target state without requiring knowledge of the items of the source state and the target state.

14. The method of claim 13 wherein comparing includes comparing a hash for each item of the first list of keys and the second list of keys to allow comparing without requiring knowledge of the items of the source state and the target state.

15. The method of claim 13 wherein the outputting includes indicating reasons for differences between the first plurality of items of the source state and the second plurality of items of the target state.

16. The method of claim 13 wherein the outputting preserves order between the source state and the target state so that the list of keys of items that are different has information to act upon to make the source state equal to the target state.

17. The method of claim 13 wherein comparing includes for each item of the source state an item in the target state is located and compared.

18. The method of claim 13 wherein the items of the source state and the items of the target state include files.

19. The method of claim 13 wherein the items of the source state and the items of the target state include files, folders, database tables, database views, database table columns, database table rows, database metadata, database scripts, security descriptors, computer metadata, or other objects or data used.

20. For a first computer hardware having a source state and a second computer hardware having a target state, a media containing instructions readable by a computer to perform a method thereon, the method comprising:
receiving a first list of keys, each of the keys associated with a different one of a first plurality of items of the source state;
receiving a second list of keys, each of the keys associated with a different one of a second plurality of items of the target state;
comparing the first list with the second list; and
outputting a list of keys of items that are different between the first plurality of items of the source state and the second plurality of items of the target state without requiring knowledge of the items of the source state and the target state.
